(19) United States
(12) Patent Application Publication
(10) Pub. No.: US 2020/0105223 A1
(43) Pub. Date: Apr. 2, 2020

(54) DISPLAY DEVICE, SCREEN BURN-IN INHIBITION METHOD, AND RECORDING MEDIUM

(71) Applicant: Casio Computer Co., Ltd., Tokyo (JP)

(72) Inventor: Masanori ISHIHARA, Tokyo (JP)

(21) Appl. No.: 16/567,226

(22) Filed: Sep. 11, 2019

(30) Foreign Application Priority Data
Oct. 1, 2018 (JP) 2018-186675

(51) Int. Cl. G09G 5/10; G09G 5/38

(52) U.S. Cl. CPC G09G 5/10; G09G 5/38; G09G 2340/0464; G09G 2320/0626; G09G 2320/046

(57) ABSTRACT

A display device includes a display and a processor. The processor is configured to change a processing level of a screen burn-in inhibition processing based on a first display content displayed on the display. The processor acquires information related to the first display content, and changes the processing level of the screen burn-in inhibition processing based on the acquired information.

### CROSS-REFERENCE TO RELATED APPLICATIONS

This application is based upon and claims the benefit of priority from prior Japanese patent application No. 2018-186675, filed on Oct. 1, 2018, the entire contents of which are incorporated herein by reference.

### TECHNICAL FIELD

The present disclosure relates to a display device, a screen burn-in inhibition method, and a recording medium.

### BACKGROUND ART

A large number of electronic devices are equipped with displays, such as a liquid crystal display or an organic EL display, for displaying. It is known that when such a display outputs the same information display for a long time, previously displayed information is displayed as a lagged image even if the displayed information is updated, and a phenomenon called “screen burn-in” occurs, which deteriorates a display function.

JP-A-H8-286647 describes a technique in which a portion of an image portion is moved in a screen to execute a screen burn-in inhibition processing (screen saver), so as to inhibit screen burn-in when an electronic device is not operated during a predetermined time.

Although in related art as described above, the screen burn-in can be inhibited when the display outputs the information display, it may be difficult to reduce power consumption of the electronic device when the information display is performed.

### SUMMARY

A display device, a screen burn-in inhibition method, and a recording medium are disclosed.

According to one aspect of the disclosure, a display device includes a display and a processor. The processor is configured to change a processing level of a screen burn-in inhibition processing based on a first display content displayed on the display.

### BRIEF DESCRIPTION OF DRAWINGS

FIG. 1 is a schematic view of an electronic device.

FIG. 2 is a block diagram showing a hardware configuration of the electronic device.

FIG. 3 shows an example of a transition mode of operation states of the electronic device.

FIG. 4A is a schematic view showing a display example of an analog timepiece map display as an example of a display content.

FIG. 4B is a table showing characteristics of types of a display content of a first display in a low power state.

FIG. 5 is a functional block diagram showing a functional configuration for executing a screen burn-in inhibition control processing.

FIG. 6 is an explanatory diagram of an image shift processing.

FIG. 7 shows an example of an image shift table.

FIG. 8 is a flowchart showing a flow of the screen burn-in inhibition control processing.

### DESCRIPTION OF EMBODIMENTS

An embodiment will be described in detail with reference to accompanying drawings.

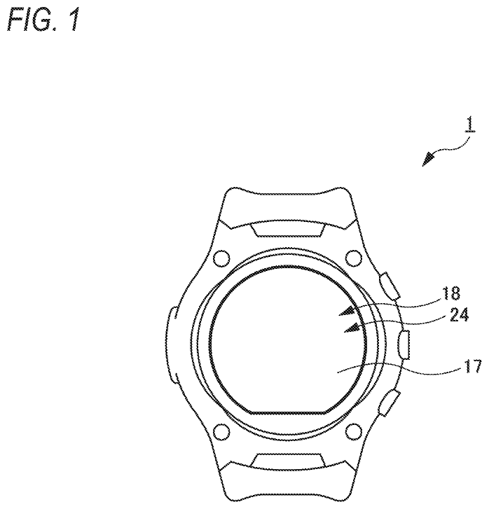

FIG. 1 is a schematic view of an electronic device 1. As shown in FIG. 1, the electronic device 1 of the present embodiment is configured as a wristwatch-type device (such as a smart watch). The electronic device 1 includes a first display 18 and a second display 24 (described below), and the second display 24 is stacked on the first display 18. Further, a touch sensor 17, which will be described below, is provided on the second display 24. For this reason, in the electronic device 1, display of the second display 24 can be superimposed on display of the first display 18, and a display content can be touched to be operated. Hereinafter, a user refers to a user of the electronic device 1. Typically, the user wears and uses the electronic device 1 on a wrist.

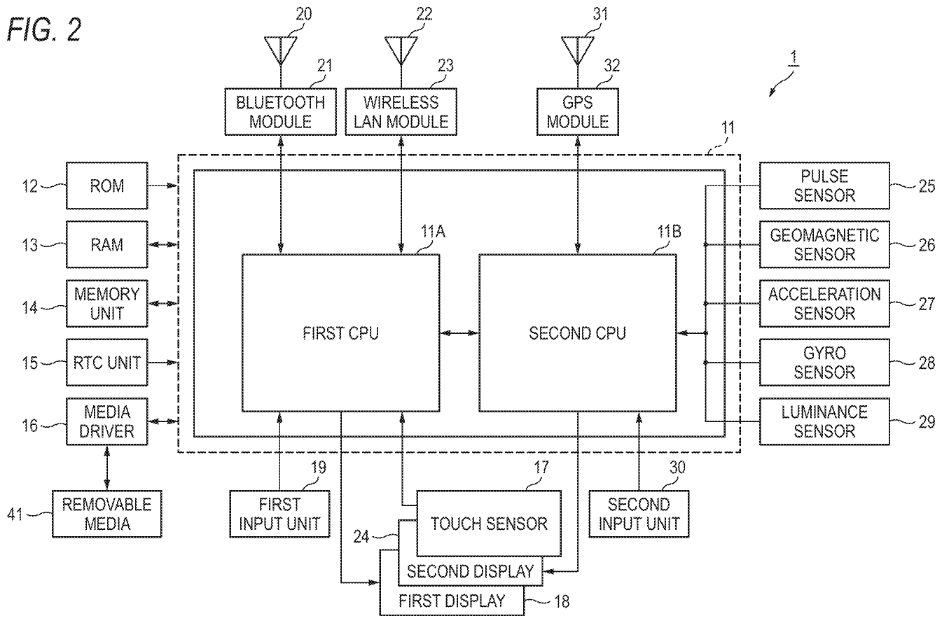

FIG. 2 is a block diagram showing a hardware configuration of the electronic device 1. As shown in FIG. 2, the electronic device 1 includes: a central processing unit (CPU) 11; a read only memory (ROM) 12; a random access memory (RAM) 13; a memory unit 14; a real time clock (RTC) unit 15; a media driver 16; a touch sensor 17; a first display 18; a first input unit 19; a Bluetooth (registered trademark) antenna 20; a Bluetooth module 21; a wireless local area network (LAN) antenna 22; a wireless LAN module 23; a second display 24; a pulse sensor 25; a geomagnetic sensor 26; an acceleration sensor 27; a gyro sensor 28; a luminance sensor 29; a second input unit 30; a global positioning system (GPS) antenna 31; and a GPS module 32.

The CPU 11 includes a first CPU 11A and a second CPU 11B. The first CPU 11A performs various types of arithmetic processing and executes processing of an operating system (OS), so as to control smartphone-like functions in the electronic device 1. In the present embodiment, the first CPU 11A displays, on the first display 18, reception of an electronic mail or a message related to weather information received via the Bluetooth module 21 or the wireless LAN module 23, and receives an operation input via the touch sensor 17. The first CPU 11A recognizes voice input via the first input unit 19, and performs processing related to various functions implemented as the smartphone-like functions.

In the present embodiment, the first CPU 11A acquires a time signal from the RTC unit 15 at a predetermined timing.

The second CPU 11B executes processing of specific programs to instruct display of the second display 24, to acquire detection results of various sensors, and to perform processing related to various functions implemented as wristwatch functions. In the present embodiment, the second CPU 11B calculates time with reference to the time signal input from the first CPU 11A, and displays time, day of a week or date on the second display 24. Since the processing of the specific program executed by the second CPU 11B (calculation of time and the like) is a simpler operation than the processing of the OS executed by the first CPU 11A, a processing load thereof is small thus the processing can be executed with low power consumption. For this reason, specifications of hardware required for the second CPU 11B may be lower than those required for the first CPU 11A.

The ROM 12 is capable of reading data from the first CPU 11A and the second CPU 11B, and stores various programs and initial setting data to be executed by the first CPU 11A and the second CPU 11B. For example, the ROM 12 stores a program of the OS executed by the first CPU 11A, various programs executed under management of the OS, or the specific program executed by the second CPU 11B (here, a built-in program for realizing the functions of the wristwatch).

The RAM 13 is capable of reading data from and writing data to the first CPU 11A and the second CPU 11B, provides work memory space for the first CPU 11A and the second CPU 11B, and stores temporary work data. For example, the RAM 13 provides a system area or a work area when the first CPU 11A executes the OS, and provides a memory area when the second CPU 11B executes the specific program.

The memory unit 14 is a nonvolatile memory capable of reading data from and writing data to the first CPU 11A and the second CPU 11B, and is, for example, a flash memory or an electrically erasable and programmable read only memory (EEPROM). The memory unit 14 stores various types of data (data of various setting contents) generated by the various smartphone-like functions or the wristwatch functions.

The RTC unit 15 generates the time signal.

The media driver 16 reads information stored in a removable medium 41, or stores various information in the removable medium 41, such as data detected by the various sensors. The removable medium 41 includes a magnetic disk, an optical disk, a magneto-optical disk, or a semiconductor memory.

The touch sensor 17 is an electrostatic capacitance type touch sensor or a resistance film type touch sensor provided on a display screen of the second display 24. The touch sensor 17 detects a touch operation position and an operation content of the user with respect to an operation surface, generates a signal corresponding to the operation, and outputs the signal to the first CPU 11A as an input signal.

The first display 18 is configured by an organic EL display (OLED), and displays various types of information on a display screen in accordance with control of the first CPU 11A.

The first input unit 19 includes a microphone that converts voice into an electric signal, and outputs a signal indicating input voice (such as a voice command for operation) to the first CPU 11A.

The Bluetooth antenna 20 is an antenna that transmits and receives electromagnetic waves based on Bluetooth standards, and is configured by, for example, a monopole antenna or the like. The Bluetooth antenna 20 transmits a wireless communication electric signal input from the Bluetooth module 21 as an electromagnetic wave, converts a received electromagnetic wave into an electric signal, and outputs the electric signal to the Bluetooth module 21.

The Bluetooth module 21 transmits a signal to another device via the Bluetooth antenna 20 in accordance with an instruction from the first CPU 11A. The Bluetooth module 21 receives a signal transmitted from another device, and outputs information indicated by the received signal to the first CPU 11A. The wireless LAN antenna 22 is an antenna capable of receiving a radio wave having a frequency corresponding to wireless communication used by the wireless LAN module 23, and is configured by, for example, a loop antenna or a rod antenna. The wireless LAN antenna 22 transmits a wireless communication electric signal input from the wireless LAN module 23 as an electromagnetic wave, converts a received electromagnetic wave into an electric signal, and outputs the electric signal to the wireless LAN module 23.

The wireless LAN module 23 transmits a signal to another device via the wireless LAN antenna 22 in accordance with an instruction from the first CPU 11A. The wireless LAN module 23 receives a signal transmitted from another device, and outputs information indicated by the received signal to the first CPU 11A.

The second display 24 is configured by a polymer network (PN) liquid crystal display partially or entirely allowing light to pass through, and displays various types of information on the display screen (in this case, for example, a segment display) in accordance with control of the second CPU 11B.

In the present embodiment, the PN liquid crystal display of the second display 24 is stacked on the display screen of the organic EL display of the first display 18 described above, for example. In this PN liquid crystal display, liquid crystal molecules are irregularly arranged in a region where no electric potential is applied, and light is reflected. That is, the display is performed by the PN liquid crystal display in the region where no electric potential is applied. Meanwhile, in a region where an electric potential is applied, the liquid crystal molecules are aligned vertically with respect to the display screen, thus light is allowed to pass through. That is, since the light from the organic EL display is allowed to pass through in the region where the electric potential is applied, the display performed by the organic EL display can be visually recognized through the PN liquid crystal display. That is, a display region of the electronic device 1 can be displayed in a superimposed state where the display performed by the second display 24 is superimposed on the display performed by the first display 18.

The pulse sensor 25 is installed on a back surface side (a side facing the wrist of the user) of the electronic device 1, and detects a pulse of the user that wears the electronic device 1. The pulse sensor 25 outputs a detected pulse to the second CPU 11B.

The geomagnetic sensor 26 detects a direction of geomagnetism and outputs information indicating the detected direction of the geomagnetism to the second CPU 11B.

The acceleration sensor 27 detects acceleration in three axial directions of the electronic device 1, and outputs information indicating the detected acceleration to the second CPU 11B.

The gyro sensor 28 detects angular velocities in the three axial directions of the electronic device 1, and outputs information indicating the detected angular velocities to the second CPU 11B.

The luminance sensor 29 is installed at a predetermined position on the back surface side of the first display 18, detects brightness (luminance) of the display region of the electronic device 1, and outputs information indicating the detected brightness to the second CPU 11B.

The second input unit 30 includes various types of buttons and inputs various types of information in response to an instruction operation of the user.

The GPS antenna 31 receives a radio wave transmitted from a satellite of GPS, converts the radio wave into an electric signal, and outputs the converted electric signal (hereinafter referred to as a “GPS signal”) to the GPS module 32.

The GPS module 32 detects current time indicated by a position (latitude, longitude, altitude) of the electronic device 1 and the GPS, based on the GPS signal input from the GPS antenna 31. The GPS module 32 outputs information indicating the detected position and the current time to the second CPU 11B.

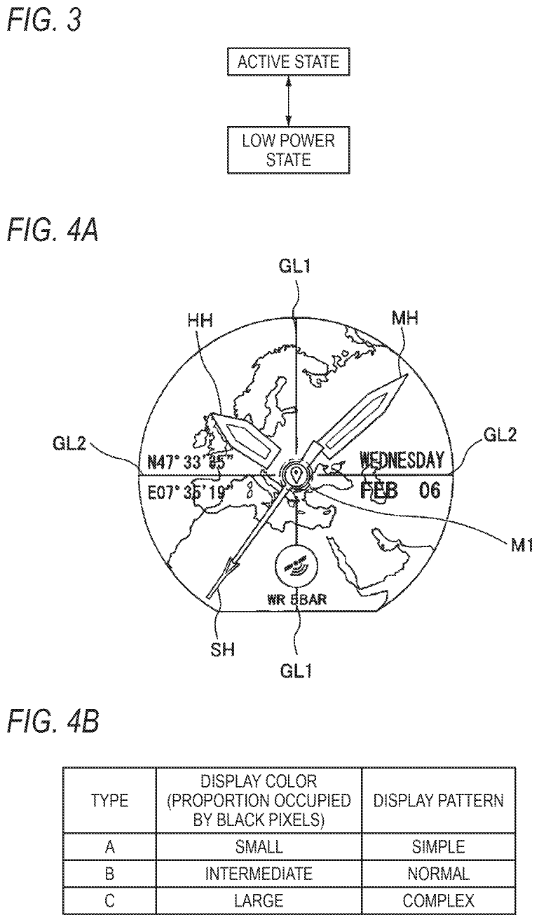

FIG. 3 shows an example of a transition mode of operation states of the electronic device 1.

The operation states of the electronic device 1 include an active state and a low power state.

In the active state, luminance of the display screen of the first display 18 is a relatively high normal value, and various functions can be executed. The normal value may be adjustable by the user. A transition from the active state to the low power state may be performed, for example, when a non-operation state and a no-input state are continued for a predetermined time or longer in the active state.

The low power state is a standby state waiting for input, in which the luminance of the display screen of the first display 18 is lower than the normal value so as to save power as compared with the active state. In the low power state, a processing load of the first CPU 11A is relatively low, and a part or all of the various functions may not be executable. For example, when input is performed via the touch sensor 17 or the first input unit 19, or when an electronic mail or the like is received via the Bluetooth module 21 or the wireless LAN module 23, a transition from the low power state to the active state may be performed.

A display content of the first display 18 in the low power state (an example of a second display content) corresponds to a display content of the first display 18 in the previous active state (an example of a first display content), these display contents may be completely the same, or a portion thereof may be omitted. For example, when the display content of the first display 18 in the active state includes displaying time by a second hand (see a second hand display SH in FIG. 4A), the display content of the first display 18 in the low power state may not include the display of the second hand.

It should be noted that, in modifications other states may be provided in addition to the active state and the low power state, or transition conditions may be different from those described above.

FIG. 4A is a schematic view showing a display example of an analog timepiece map display as an example of the display content. In the example shown in FIG. 4A, a mark M1 indicating a current location is displayed, and guide lines GL1 and GL2 are displayed, which pass through a center of a display region (a current position and a rotation center of images of watch hands). In the vicinity of the guide lines GL1 and GL2, numerical values of latitude and longitude, which indicate positions on the map at which the guide lines GL1 and GL2 are located, are displayed. Accordingly, the user can easily grasp the latitude and longitude of the current position at an intersection of the guide lines GL1 and GL2.

FIG. 4B is a table showing characteristics of types of the display content of the first display 18 in the low power state.

There are a plurality of types of display contents of the first display 18 in the active state. As an example, there are three types (Type A to Type C) in the present embodiment. It should be noted that the types of the display contents can be selected by the user in the active state.

The number of types of display contents of the first display 18 in the low power state is also three (Type A to Type C), corresponding to the types of the display contents of the first display 18 in the active state. Hereinafter, the types of the display contents of the first display 18 are the types in the low power state, unless otherwise specified.

Differences between the types of the display contents of the first display 18 relate to a display color and a display pattern.

As for the display color, the difference between the types relates to an amount of black in the display color, such as a background display color. Here, a proportion (ratio) of black pixels in total pixels is used as an index for indicating the amount of black. For example, if the total number of pixels is referred to as Px and the number of black pixels is referred to as Pb, the index indicating the amount of black may be expressed by Pb/Px. In the present embodiment, as an example, the proportion of black pixels in the total pixels is relatively small in Type A, the proportion of black pixels in the total pixels is relatively large in Type C, and the proportion of black pixels in the total pixels is intermediate in Type B, between Type A and Type C.

It should be noted that, in modifications the amount of black may not be quantified by calculation as described above, and may be based on sensory evaluation of humans. For example, if a background is white, the background may be regarded as having little black. If a background is black, the background may be regarded as having much black. If a background is gray, the background may be regarded as having neither much black nor little black.

As for the display pattern, the difference between the types relates to a complexity degree of a pattern. Here, a probability, that pixel values match between one specific pixel and pixels located on upper or lower sides (vertical direction), or on left or right sides (horizontal direction) with respect to the one pixel within a predetermined number of pixels, is used as an index for indicating the complexity degree of a pattern. If the pattern is simpler, the probability is higher. The predetermined number of pixels may be set to any numbers, for example, one pixel. It should be noted that as the index for indicating the complexity degree of the pattern, the probability may be calculated while the specific one pixel is changed, and an average value of the probability may be finally used. The average may be taken in a case where four directions including upper and lower directions (vertical direction) or left and right directions (horizontal direction) are compared, and diagonal directions may further be taken into consideration. In a simpler manner, only one direction among the four directions including the upper and lower directions (vertical direction) or the left and right directions (horizontal direction) may be considered. In the present embodiment, as an example, a pattern of Type A has a relatively low complexity degree (relatively simple), a pattern of Type C has a relatively high complexity degree (relatively complex), and the complexity degree of a pattern of Type B is between Type A and Type B (normal).

It should be noted that, in modifications the complexity degree of the pattern may not be quantified by calculation as described above, and may be based on sensory evaluation of humans. For example, if a design is monotony, the design may be regarded as having a relatively low complexity degree. If a design is complex, the design may be regarded as having a relatively high complexity degree. If a design is neither monotony nor complex, the design may be regarded as having an intermediate complexity degree. In a simpler manner, if sizes of hands of a timepiece (see hand display HH that indicates hours or hand display MH that indicates minutes in FIG. 4A) are relatively large, the complexity degree is regarded as relatively low. If hands of a timepiece are relatively fine, the complexity degree is regarded as relatively high. If hands of a timepiece are intermediate, the complexity degree may be regarded as intermediate.

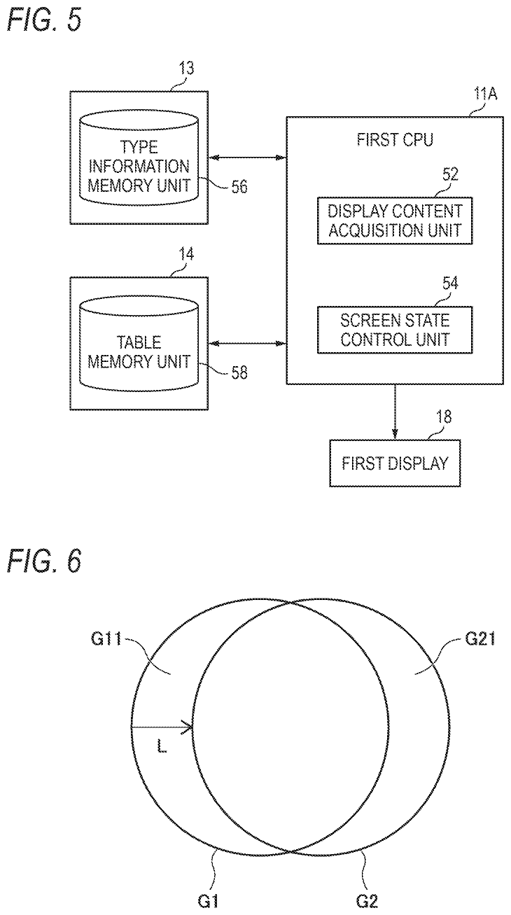

Next, a functional configuration of the electronic device 1 will be described. FIG. 5 is a functional block diagram showing a functional configuration for executing a screen burn-in inhibition control processing.

The screen burn-in inhibition control processing is configured to save power while inhibiting screen burn-in of the display screen of the first display 18 in the low power state according to the display content of the first display 18.

When the screen burn-in inhibition control processing is executed, as shown in FIG. 5, a display content acquisition unit 52 and a screen state control unit 54 function in the first CPU 11A, a type information memory unit 56 is implemented in the RAM 13, and a table memory unit 58 is implemented in the memory unit 14. The table memory unit 58 may also be implemented in the ROM 12.

The display content acquisition unit 52 acquires type information from the type information memory unit 56. The type information indicates a type of a present display content of the first display 18. Specifically, if the present display content of the first display 18 is Type A, the type information indicates Type A. If the present display content of the first display 18 is Type B, the type information indicates Type B. If the present display content of the first display 18 is Type C, the type information indicates Type C. Latest type information is always stored in the type information memory unit 56. That is, when the type of the display content of the first display 18 is changed, the type information of the type information memory unit 56 is updated accordingly.

The screen state control unit 54 controls contents of a screen burn-in inhibition processing based on the display content of the first display 18. When the transition from the active state to the low power state is performed, the screen state control unit 54 controls the contents of the screen burn-in inhibition processing.

The screen burn-in inhibition processing is a main part of the screen burn-in inhibition control processing, and inhibits the screen burn-in of the first display 18. In the present embodiment, as an example, the screen burn-in inhibition processing includes: processing configured to reduce luminance of the display screen of the first display 18 (hereinafter, also referred to as “luminance reduction processing”); and processing configured to change pixel values of a plurality of pixels based on the second display content (hereinafter, also referred to as “image shift processing”). This is because, the screen burn-in is more difficult to occur when luminance of the pixels becomes lower, and the screen burn-in is more difficult to occur when the pixel values of the pixels change at a high frequency.

In the present embodiment, as an example, the image shift processing shifts an image indicating the second display content in a predetermined direction on the screen. The predetermined direction may be any one of upper, lower, left, right and diagonal directions, or may be a combination thereof, and may be changed for each processing to be shifted. When the image indicating the second display content is shifted from an initial position in the predetermined direction on the screen, the image goes out from the screen on the predetermined direction side (therefore, becomes hidden). An end portion of the image comes to inside of the screen on an opposite side of the predetermined direction. Specifically, as schematically shown in FIG. 6, if an image G1 is an initial image (an image that fits exactly within the screen) and if an image G2 is slipped away to the right of the image G1 by a distance L (a distance corresponding to a predetermined number of pixels), an image portion G21 of the image G2 after the slipping goes out from the screen, a region where an image portion G11 of the image G1 is present on the screen becomes a region having no image therein. In this case, the region on the screen in which the image portion G11 of the image G1 is present may be filled with another new image.

Here, the screen burn-in does not occur in black pixels, and is thus difficult to occur when the number of black pixels is large. The screen burn-in occurs when a state, in which pixels have pixel values other than black (in particular, pixel values closer to white) are provided, continues for a relatively long time. Therefore, if the display pattern is simple, even if the image is shifted by the image shift processing, a relatively large number of pixels, whose pixel values do not change, occur easily, and the screen burn-in occurs easily. That is, if shift amounts of images are the same, the screen burn-in occurs easily as the pattern is simple.

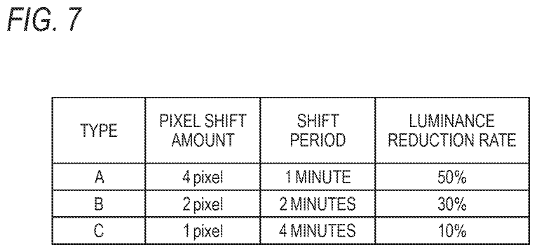

Therefore, in the present embodiment, the screen state control unit 54 controls the contents of the screen burn-in inhibition processing based on the display color of the display content of the first display 18 and the complexity degree of the pattern. Specifically, the screen state control unit 54 refers to an image shift table in the table memory unit 58, and executes the screen burn-in inhibition processing with processing contents corresponding to the type of the display content of the first display 18. The image shift table defines the processing contents corresponding to the type of the display content of the first display 18, and is, for example, a table as shown in FIG. 7. In an example shown in FIG. 7, pixel shift amounts, shift periods, and luminance reduction rates are defined for each type of the display content of the first display 18. Specifically, as for Type A, the pixel shift amount is four pixels, the shift period is 1 minute, and the luminance reduction rate is 50%. As for Type B, the pixel shift amount is two pixels, the shift period is 2 minutes, and the luminance reduction rate is 30%. As for Type C, the pixel shift amount is one pixel, the shift period is 4 minutes, and the luminance reduction rate is 10%.

The pixel shift amount is a shift amount of a pixel generated by one shift processing in the image shift processing. For example, if the pixel shift amount is four pixels, the image is shifted by four pixels (the distance L of FIG. 6 is four pixels) by one shift processing in the image shift processing. In general, as the pixel shift amount increases, the screen burn-in is more difficult to occur. This is because, as the pixel shift amount increases, the number of pixels having the same pixel value before and after shifting decreases. In consideration of such a point, in the example shown in FIG. 7, a relatively large pixel shift amount is associated with Type A, in which the screen burn-in occurs easily since there are relatively less black pixels. A relatively small pixel shift amount is associated with Type C, in which the screen burn-in is difficult to occur since there are relatively more black pixels. An intermediate pixel shift amount is associated with the intermediate Type B. In this way, in the example shown in FIG. 7, appropriate pixel shift amounts are associated according to the number of black pixels.

The shift period is a period in which the image shift processing is executed. For example, if the shift period is one minute, the image shift processing is executed every one minute. As described above, the screen burn-in occurs when the state, in which the pixels have the pixel values other than black (in particular, the pixel values closer to white) are provided, continues for the relatively long time. Therefore, for the same display color and the same display pattern, the screen burn-in is more difficult to occur as the shift period becomes shorter. As described above, if the display pattern is simple, even if the image is shifted by the image shift processing, the relatively large number of pixels, whose pixel values do not change, occur easily, and the screen burn-in occurs easily. In consideration of such a point, in the example shown in FIG. 7, a relatively short shift period is associated with Type A, in which the screen burn-in occurs easily if the period of performing the image shift processing is long since there are relatively less black pixels and a relatively simpler display pattern. A relatively long shift period is associated with Type C, in which the screen burn-in is difficult to occur since there are relatively more black pixels and a relatively complex display pattern. An intermediate shift period is associated with the intermediate Type B. In this way, in the example shown in FIG. 7, appropriate shift periods are associated according to the number of black pixels and the complexity degree of the display pattern.

On the other hand, power consumption is larger when the shift period is short. That is, assuming that power consumption per image shift processing is constant, the number of times of image shift processing per unit time increases as the shift period becomes shorter, and the power consumption is thus increased. In the example shown in FIG. 7, since appropriate shift periods are associated according to the number of black pixels and the complexity degree of the display pattern as described above, power can be saved while inhibiting the screen burn-in of the display screen of the first display 18.

The luminance reduction rate is a reduction rate of luminance reduced in the luminance reduction processing, and is a reduction rate with respect to a normal value (a luminance value in the active state). For example, if the luminance reduction rate is 30%, the luminance is set to 70% of the normal value. As described above, the screen burn-in occurs easily as the luminance of the pixel becomes higher. In consideration of such a point, in the example shown in FIG. 7, a relatively large luminance reduction rate is associated with Type A, in which the screen burn-in occurs easily since there are relatively less black pixels and a relatively simpler display pattern. A relatively small luminance reduction rate is associated with Type C, in which the screen burn-in is difficult to occur since there are relatively more black pixels and a relatively complex display pattern. An intermediate luminance reduction rate is associated with the intermediate Type B. In this way, in the example shown in FIG. 7, appropriate luminance reduction rates are associated according to the number of black pixels and the complexity degree of the display pattern.

As the luminance reduction rate increases, the power consumption decreases. In this regard, in the example shown in FIG. 7, since appropriate luminance reduction rates are associated according to the number of black pixels and the complexity degree of the display pattern as described above, power can be saved while inhibiting the screen burn-in of the display screen of the first display 18.

On the other hand, as the luminance reduction rate becomes lower, a state gets closer to the active state, and visibility of the display content of the first display 18 is increased. In this regard, in the example shown in FIG. 7, since the appropriate luminance reduction rates are associated according to the number of black pixels and the complexity degree of the display pattern as described above, a relatively high visibility can be ensured for Type C, in which the screen burn-in is difficult to occur, while inhibiting the screen burn-in of the display screen of the first display 18.

In this way, according to this embodiment, since the contents of the screen burn-in inhibition processing is controlled according to characteristics of the display content of the first display 18, the screen burn-in of the first display 18 can be inhibited in the low power state while reducing the power consumption of the electronic device 1 in the low power state (power consumption related to the display of the first display 18).

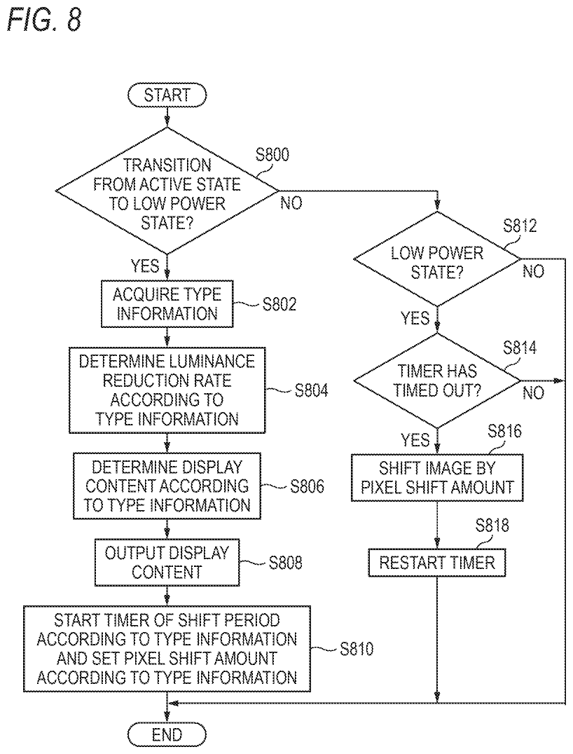

FIG. 8 is a flowchart showing a flow of the screen burn-in inhibition control processing executed in the electronic device 1 of FIG. 1 which has the functional configuration of FIG. 5.

The screen burn-in inhibition control processing is started when the electronic device 1 is turned on, and is ended when an operation is performed to turn off the electronic device 1.

In step S800, the first CPU 11A determines whether a transition event, from the active state to the low power state, occurs. If a determination result thereof is “YES”, the processing proceeds to step S802, otherwise the processing proceeds to step S812.

In step S802, the first CPU 11A acquires the type information in the type information memory unit 56.

In step S804, the first CPU 11A refers to the image shift table in the table memory unit 58, and determines the luminance reduction rate according to the type information (any one among Type A to Type C) acquired in step S802.

In step S806, the first CPU 11A determines the display content of the first display 18 according to the type information acquired in step S802.

In step S808, the first CPU 11A outputs an image of the display content determined in step S806 with a luminance based on the luminance reduction rate determined in step S804.

In step S810, the first CPU 11A refers to the image shift table in the table memory unit 58, starts a timer T corresponding to the shift period (see FIG. 7) according to the type information (any one among Type A to Type C) acquired in step S802, and set the pixel shift amount (see FIG. 7) according to the type information acquired in step S802.

In step S812, the first CPU 11A determines whether the present state is the low power state. If a determination result thereof is “YES”, the processing proceeds to step S814, otherwise the processing is ended.

In step S814, the first CPU 11A determines whether the timer T has timed out. After the start of the timer T, the timer T times out when the shift period (see FIG. 7) according to the type information acquired in step S802 elapses. If a determination result thereof is “YES”, the processing proceeds to step S816, otherwise the processing is ended.

In step S816, the first CPU 11A shifts an output image in the predetermined direction by the pixel shift amount set in step S810. The predetermined direction may be randomly determined, or may be selected in order from the top, bottom, left, right, and the like. In this case, the predetermined direction may be determined such that the image draws a circle by a series of image shift processings.

In step S818, the first CPU 11A restarts the timer T.

According to the processing shown in FIG. 8, when the transition from the active state to the low power state is performed, the contents of the screen burn-in inhibition processing is controlled based on the display content of the first display 18 at that time. That is, the luminance reduction processing and the image shift processing are executed with the luminance reduction rate, the pixel shift amount, and the shift period according to the type information. Accordingly, the power consumption related to the display of the first display 18 of the electronic device 1 can be reduced in the low power state while inhibiting the screen burn-in of the first display 18 in the low power state.

It should be noted that the above-described series of processings can be executed by hardware, or can be executed by software.

The functional configuration as described above is merely an example, and is not particularly limited. That is, as long as the electronic device 1 has a function that can execute the above-described series of processings as a whole, what functional blocks are used to realize the function is not particularly limited to the functional configuration as described above. One functional block may be configured by a single piece of hardware, a single piece of software, or a combination thereof.

The functional configuration of the present embodiment is realized by a processor that executes arithmetic processing. Processors that can be used in the present embodiment include a processor configured by a single processing device among various processing devices, such as a single processor, a multiprocessor, and a multi-core processor, or a processor configured by a combination of the various processing devices and processing circuits, such as an application specific integrated circuit (ASIC) or a field-programmable gate array (FPGA).

When the series of processings is executed by software, a program constituting the software is installed in a computer or the like from a network or a recording medium. The computer may be incorporated in dedicated hardware. The computer may be a computer capable of executing various functions by installing various programs, such as a general-purpose personal computer.

A recording medium including such a program is configured not only by the removable medium 41 of FIG. 2 disposed separately from a device main body to provide the program to the user, but also by a recording medium or the like provided to the user in a state of being incorporated in the device main body in advance. The removable medium 41 includes, for example, a magnetic disk (including a floppy disk), an optical disk, or a magneto-optical disk. The optical disk is configured by, for example, a compact disk-read only memory (CD-ROM), a digital versatile disk (DVD), a Blu-ray (registered trademark) disc, or the like. The magneto-optical disk is configured by a mini-disk (MD) or the like. The recording medium provided to the user in the state of being incorporated in the device main body in advance includes, for example, the ROM 12 of FIG. 2 in which the program is recorded, a semiconductor memory included in the memory unit 14 of FIG. 2, or the like.

In the present description, the steps of describing the program recorded on the recording medium include processings performed in time series according to the order, and processings performed in parallel or separately without necessarily being processed in the time series.

Although each embodiment is described above in detail, the present invention is not limited to specific embodiments, and various modifications and changes can be made within the scope described in the claims. It is also possible to combine all or a plurality of the constituent elements of the above-described embodiments.

For example, although in the above-described embodiment the electronic device 1 includes the first display 18 and the second display 24, the electronic device 1 may only include the first display 18.

Although in the embodiment described above, the screen burn-in inhibition control processing is applied to the first display 18, instead or in addition, the screen burn-in inhibition control processing may be applied to the second display 24.

In the embodiment described above, the first display 18 on which the display content is displayed is configured by the OLED, the first display 18 may also be configured by other displays, such as a liquid crystal display.

Although in the embodiment described above, the CPU 11 of the electronic device 1 includes the first CPU 11A and the second CPU 11B, the present invention is not limited thereto, and the CPU 11 may be one single CPU including functions of both the first CPU 11A and the second CPU 11B.

Although in the above embodiment, the electronic device 1 to which the present invention is applied is described as a wristwatch-type device (such as a smart watch) as the example, the present invention is not limited thereto. For example, the present invention can be generally applied to an electronic device having a luminance adjustment function. Specifically, for example, the present invention is applicable to a notebook personal computer, a printer, a television receiver, a video camera, a portable navigation device, a mobile phone, a smartphone, a portable game machine, or the like.

Although in the above-described embodiment, the pixel shift amount and the shift period are associated with each type of the display content of the first display 18, the configuration may be that only one of the pixel shift amount or the shift period is associated. In this case, in a type in which the screen burn-in occurs easily, the pixel shift amount is larger, and the shift period is shorter.

In the embodiment described above, the occurrence of the screen burn-in is considered based on the indexes related to the display color and the display pattern, the occurrence of the screen burn-in may also be considered based on only one index related to the display color or the display pattern. Alternatively, for each type of the display content of the first display 18, one index value obtained by combining the index related to the display color and the index related to the display pattern may be considered.

Although in the above-described embodiment, the image is shifted linearly in the image shift processing, the present invention is not limited thereto. For example, the image may be shifted in a manner that the image rotates about a center of the screen as a rotation center. In this case, the outgoing region described above with reference to FIG. 6 can be minimized, and a decrease in the visibility of the screen caused by the image shift processing can be inhibited.

What is claimed is:

1. A display device, comprising:
a display; and
a processor, configured to change a processing level of a screen burn-in inhibition processing based on a first display content displayed on the display.

2. The display device according to claim 1, wherein the processor acquires information related to the first display content, and changes the processing level of the screen burn-in inhibition processing based on the acquired information.

3. The display device according to claim 2, wherein the processor acquires information related to a display color or a display pattern as the information related to the first display content.

4. The display device according to claim 2, wherein the changing of the processing level of the screen burn-in inhibition processing includes: changing a luminance of the display.

5. The display device according to claim 3, wherein the changing of the processing level of the screen burn-in inhibition processing includes: changing a luminance of the display.

6. The display device according to claim 2, wherein the changing of the processing level of the screen burn-in inhibition processing includes: changing pixel values of a plurality of pixels based on a second display content corresponding to the first display content displayed on the display.

7. The display device according to claim 3, wherein the changing of the processing level of the screen burn-in inhibition processing includes: changing pixel values of a plurality of pixels based on a second display content corresponding to the first display content displayed on the display.

8. The display device according to claim 4, wherein the changing of the processing level of the screen burn-in inhibition processing includes: changing pixel values of a plurality of pixels based on a second display content corresponding to the first display content displayed on the display.

9. The display device according to claim 5, wherein the changing of the processing level of the screen burn-in inhibition processing includes: changing pixel values of a plurality of pixels based on a second display content corresponding to the first display content displayed on the display.

10. The display device according to claim 6, wherein the changing of the pixel value of the plurality of pixels based on the second display content includes: moving an image indicating the second display content in a predetermined direction within a screen of the display.

11. The display device according to claim 7, wherein the changing of the pixel value of the plurality of pixels based on the second display content includes: moving an image indicating the second display content in a predetermined direction within a screen of the display.

12. The display device according to claim 8, wherein the changing of the pixel value of the plurality of pixels based on the second display content includes: moving an image indicating the second display content in a predetermined direction within a screen of the display.

13. The display device according to claim 9, wherein the changing of the pixel value of the plurality of pixels based on the second display content includes: moving an image indicating the second display content in a predetermined direction within a screen of the display.

14. A screen burn-in inhibition method of a display device that includes a display, comprising:
changing a processing level of a screen burn-in inhibition processing based on a first display content displayed on the display.

15. A non-transitory computer readable recording medium, which records a program readable by a computer including a display, the program being configured to execute processing of:
changing a processing level of a screen burn-in inhibition processing based on a first display content displayed on the display.
